(19) United States
(12) Patent Application Publication
(10) Pub. No.: US 2014/0084816 A1
(43) Pub. Date: Mar. 27, 2014

(54) POWER CONVERTER FOR AN ELECTRICAL MACHINE AND METHOD OF OPERATING THE MACHINE

(71) Applicant: Krishnan RAMU, Blacksburg, VA (US)

(72) Inventor: Krishnan RAMU, Blacksburg, VA (US)

(21) Appl. No.: 13/837,897

(22) Filed: Mar. 15, 2013

Related U.S. Application Data
(60) Provisional application No. 61/705,566, filed on Sep. 25, 2012.

(51) Int. Cl. H02P 27/06

(52) U.S. Cl. CPC H02P 27/06
USPC 318/139

(57) ABSTRACT

A power converter has a first electrical circuit including a direct current (dc) voltage source, a first phase winding of an electrical machine, and a first switch operating in a conductive state. A second electrical circuit includes the first phase winding, a first unidirectional current device, and a capacitive storage element. A third electrical circuit includes the capacitive storage element, a second switch operating in a conductive state, and the first phase winding. A fourth electrical circuit includes the first phase winding, the dc voltage source, and a second unidirectional current device.

### CROSS-REFERENCE TO RELATED APPLICATIONS

This application claims the benefit of priority provided by U.S. provisional application 61/705,566, which was filed on Sep. 25, 2012.

### FIELD OF THE INVENTION

The invention relates to a power converter for an electrical machine and a method of operating the machine.

### BACKGROUND OF THE RELATED ART

Low-cost motor drives in vehicle applications, such as electric bikes (E-Bikes) operated with battery-stored energy, are sought because of their positive impact on the environment, the existing mass market of electric bikes, and the limited financial resources of the user community in China, India, and other developing nations. One of the significant cost elements of a motor drive is a power converter circuit, particularly its number of power devices, such as transistors and power diodes. Economy in the use of power devices translates into a reduced number of control circuit components, such as gate drives, logic power supplies, and device protection circuits; such economy also leads to reduced printed circuit board area, heat-sink volume, and weight. The use of fewer power devices also leads to lower cost of the power electronic system for the motor drive.

The use of fewer power devices restricts the freedom of operation of individual machine phases. Further, the control of a power converter requires signals, such as current and voltage signals, for feedback control or for the motor drive system control.

### SUMMARY OF THE INVENTION

Inexpensive means of measuring and estimating currents and voltages in a converter circuit that is driving a switched reluctance or a permanent magnet brushless direct current (dc) motor and use of the measured current and voltage signals in the control of the motor drive system are aspects of this disclosure. The converter and machine described herein have two phases, and the converter is supplied energy from an electrical battery supply. An embodiment of the invention for a motor drive system with more than two phases is described and generalized for any number of phases.

A control system, employing feedback current and voltage signals, is also disclosed for operating the converter circuit, such that energy in a storage capacitor of the converter circuit is kept within specified levels. The system is described in detail with application to a two-phase switched reluctance machine (SRM), which then is generalized for SRMs with more than two phases.

Methods to estimate and predict phase-winding currents and voltages, voltages across a storage capacitor and battery pack, and currents in the storage capacitor and battery are also described. The measurements of the voltages and currents may be obtained continuously or discontinuously.

One or more objects of the disclosed subject matter may be achieved by a power converter having: (1) a capacitive storage element; (2) first and second switches that each conducts current in a conductive state and does not conduct current in a non-conductive state; and (3) first and second unidirectional current devices that each conducts current unidirectionally. The capacitive storage element, first and second switches, and first and second unidirectional current elements are interconnected such that when interconnected with a dc voltage supply and a first phase winding of an electrical machine: (a) a first operational state exists in which energy is transferred from the dc voltage supply to the first phase winding when the first switch is in the conductive state, (b) a second operational state exists in which energy stored by the first phase winding during the first operational state is transferred to the capacitive storage element when the first switch is in the non-conductive state, (c) a third operational state exists in which energy stored by the capacitive storage element is transferred to the first phase winding when the second switch is in the conductive state, and (d) a fourth operational state exists in which energy stored by the first phase winding during the third operational state is transferred to dc voltage supply when the second switch is in the non-conductive state.

One or more objects of the disclosed subject matter may also be achieved by a method of operating a power converter, the method including: (1) transferring energy from a dc voltage supply to a first phase winding of an electrical machine during a first operational state, (2) transferring energy stored by the first phase winding during the first operational state to a capacitive storage element during a second operational state, (3) transferring energy stored by the capacitive storage element to the first phase winding during a third operational state, and (4) transferring energy stored by the first phase winding during the third operational state to the dc voltage supply during a fourth operational state.

One or more objects of the disclosed subject matter may also be achieved by a power converter including: (1) a first electrical circuit comprising a dc voltage source, a first phase winding of an electrical machine, and a first switch operating in a conductive state; (2) a second electrical circuit comprising the first phase winding, a first unidirectional current device, and a capacitive storage element; (3) a third electrical circuit comprising the capacitive storage element, a second switch operating in a conductive state, and the first phase winding; and (4) a fourth electrical circuit comprising the first phase winding, the dc voltage source, and a second unidirectional current device.

One or more objects of the disclosed subject matter may also be achieved by a power converter including: (1) a dc voltage supply having a first terminal electrically connected directly to a first node and a second terminal electrically connected to a second node, either directly or through a first current sensor; and (2) a first phase module. The first phase module includes: (a) a first phase winding of an electrical machine having a first terminal electrically connected directly to the first node and a second terminal electrically connected directly to a third node, (b) a capacitive storage element having a first terminal electrically connected directly to the first node and a second terminal electrically connected directly to a fourth node, (c) a first switch having a first terminal electrically connected to the second node, either directly or through a second current sensor, and a second terminal electrically connected directly to the third node, (d) a first unidirectional current device having a first terminal electrically connected to the second node, either directly or through the second current sensor, (e) and a second terminal electrically connected directly to the third node, (f) a second switch having a first terminal electrically connected directly to the third node and a second terminal electrically connected directly to the fourth node, and (g) a second unidirectional current device having a first terminal electrically connected directly to the third node and a second terminal electrically connected directly to the fourth node.

One or more objects of the disclosed subject matter may also be achieved by a method of controlling an electrical machine, the method including: (1) generating a first signal indicating whether a value representative of a voltage of a first voltage source is less than the difference between a value representative of a voltage of a second voltage source and a reference voltage value; (2) generating a second signal indicating whether the value representative of the voltage of the first voltage source equals or exceeds the sum of the value representative of the voltage of the second voltage source and the reference voltage value; (3) transferring energy from the second energy source to a phase winding of the electrical machine during a period that the first signal indicates an affirmative condition; and (4) transferring energy from the first energy source to the phase winding during a period that the second signal indicates an affirmative condition.

One or more objects of the disclosed subject matter may also be achieved by a non-volatile storage medium storing instructions that, when executed by a processor, cause the processor to implement a method comprising: (1) transferring energy from a dc voltage supply to a first phase winding of an electrical machine during a first operational state, (2) transferring energy stored by the first phase winding during the first operational state to a capacitive storage element during a second operational state, (3) transferring energy stored by the capacitive storage element to the first phase winding during a third operational state, and (4) transferring energy stored by the first phase winding during the third operational state to the dc voltage supply during a fourth operational state.

One or more objects of the disclosed subject matter may also be achieved by a non-volatile storage medium storing instructions that, when executed by a processor, cause the processor to implement a method comprising: (1) generating a first signal indicating whether a value representative of a voltage of a first voltage source is less than the difference between a value representative of a voltage of a second voltage source and a reference voltage value; (2) generating a second signal indicating whether the value representative of the voltage of the first voltage source equals or exceeds the sum of the value representative of the voltage of the second voltage source and the reference voltage value; (3) transferring energy from the second energy source to a phase winding of an electrical machine during a period that the first signal indicates an affirmative condition; and (4) transferring energy from the first energy source to the phase winding during a period that the second signal indicates an affirmative condition.

### BRIEF DESCRIPTION OF THE DRAWINGS

Preferred embodiments of the invention are described in the following paragraphs of the specification and may be better understood when read in conjunction with the drawings, in which:

FIG. 1 illustrates an embodiment of a power converter;

FIG. 2 illustrates a modular unit M within the power converter of FIG. 1;

FIG. 3 illustrates a modular unit N within the power converter of FIG. 1;

FIG. 4 illustrates an embodiment of a power converter having any number of machine phases;

FIG. 5 illustrates an embodiment of the power converter illustrated by FIG. 1 having voltage and current sensors;

FIG. 6 illustrates, for the power converter of FIG. 5, the relation of current iₛ in phase winding A and a voltage V_{A} across phase winding A;

FIG. 7 illustrates, for the power converter of FIG. 5, phase winding A current iₐ, voltage signal Vᵢₐ₁, and a sampling of voltage signal Vᵢₐ₁, identified by Vᵢₐ₁(tₛ), with respect to time for Mode 1 operation;

FIG. 8 illustrates, for the power converter of FIG. 5, voltage signal V_{tc1} relative to voltage V_{A} across phase winding A and current iₐ flowing through phase winding A for Mode 2 operation;

FIG. 9 illustrates, for the power converter of FIG. 5, voltage signal Vᵢₐ₂ relative to voltage V_{A} across phase winding A and current iₐ flowing through phase winding A for Mode 3 operation;

FIG. 10 illustrates signal voltage Vᵢₐ₂ within FIG. 9 in greater detail;

FIG. 11 illustrates, for the power converter of FIG. 5, voltage V_{A} across phase winding A, phase winding A current iₐ, and voltage signal V_{tc1} with respect to time for Mode 3 operation;

FIG. 12 illustrates the modularization of the phase A circuitry illustrated by FIG. 5;

FIG. 13 illustrates the modularization of the phase B circuitry illustrated by FIG. 5;

FIG. 14 illustrates an SRM having multiples ones of the phase units illustrated in FIGS. 12 and 13;

FIG. 15 illustrates a control system for controlling the power converter illustrated by FIG. 14; and

FIG. 16 illustrates the operation of the transistor selection block illustrated in FIG. 15.

### DETAILED DESCRIPTION OF THE INVENTION

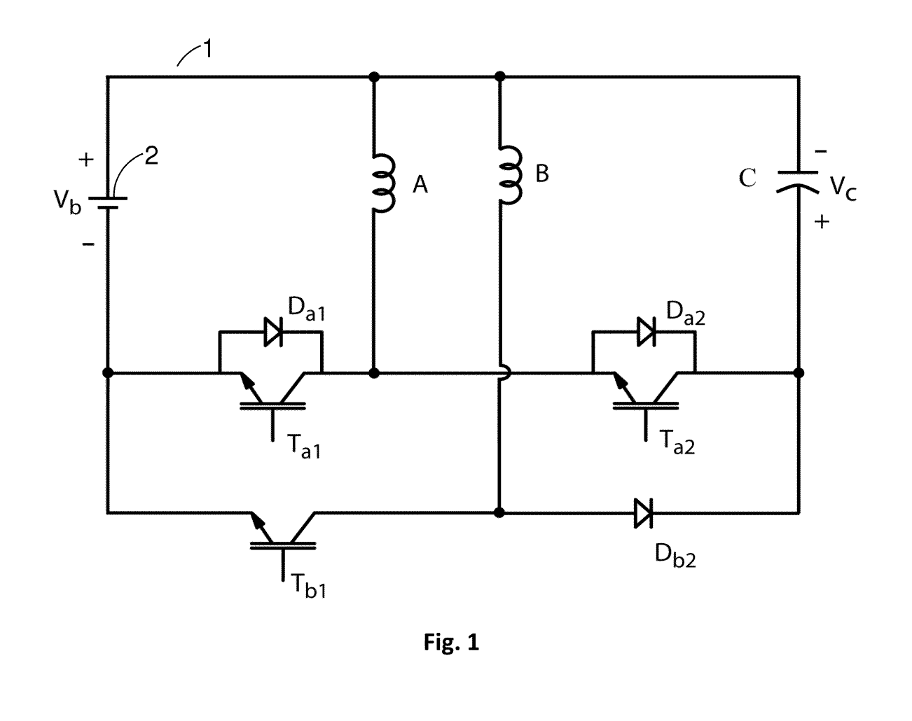

FIG. 1 illustrates an embodiment of a power converter. A power converter 1, at its input terminals, has a battery pack 2 with voltage V_{b}. A two-phase switched reluctance or a permanent magnet brushless direct current (dc) machine (PMBDCM) may be used in this embodiment. The description hereafter is only with reference to switched reluctance machine (SRM), but is equally applicable to the PMBDCM.

Phase windings A and B are two, machine phase windings of an SRM. Battery 2 has a positive terminal connected to a first terminal of phase winding A, a first terminal of phase winding B, and a first terminal of a storage capacitor C. A negative terminal of battery 2 is connected to the anode of a diode Dₐ₁, the emitter of a bipolar-junction transistor (BJT) Tₐ₁, and the emitter of a BJT T_{b1}. A second terminal of phase winding A is connected to the cathode of diode Dₐ₁, the collector of transistor Tₐ₁, the anode of a diode Dₐ₂, and the emitter of a BJT Tₐ₂. A second terminal of phase winding B is connected to the collector of transistor T_{b1} and the anode of a diode D_{b2}. A second terminal of capacitor C is connected to the cathodes of diodes Dₐ₂ and D_{b2} and the collector of a BJT Tₐ₂.

Diode Dₐ₁ and transistor Tₐ₁ are available in one package, such as in a metal-oxide semiconductor field-effect transistor (MOSFET) device or an insulated-gate bipolar transistor (IGBT) device. Similarly, diode Dₐ₂ and transistor Tₐ₂ are also available in one package, such as in a MOSFET device or an IGBT device. Such packaging of the circuit elements leads to space savings in circuit realization and cost savings in manufacture.

For simplicity of description, the devices described herein are assumed to be ideal. For example, the diodes, transistors, and interconnecting wires are considered to have a zero conduction voltage drop across them. In a practical embodiment, the conduction voltage drops may be considered. Neglecting these voltage drops and their associated losses does not change the essence of the description or the inferences drawn therefrom.

Energization of phase winding A is achieved in two ways. One way is to energize phase winding A with battery 2, and the other is to energize phase winding A with energy stored in capacitor C. Energization of phase winding A from battery 2 is designated Mode A1. Turning on transistor Tₐ₁ will apply battery voltage V_{b} across phase winding A, which will establish a current in phase winding A so as to generate a torque in the machine, say, in the clockwise (CW) direction and, hence, move a rotor of the machine in the CW direction. If phase winding A current exceeds a set limit, transistor Tₐ₁ may be turned off, which will cut off battery voltage V_{b} to phase winding A. As the current is nonzero at the turn-off time of transistor Tₐ₁, there is energy storage in the inductance of phase winding A. The energy stored in the inductance of phase winding A must be transferred to a source or result in a high rise of voltage across transistor Tₐ₁. The only way in which the energy in phase winding A can be transferred is through the flow of current through diode Dₐ₂ and capacitor C, resulting in an increase of voltage across capacitor C. The voltage of capacitor C is also applied across phase winding A and has a polarity that is conducive for current decay, not for build-up, as the current is charging capacitor C and flowing against a capacitor voltage V_{c}. When the current falls below the set limit, so as to maintain current at a desired level, transistor Tₐ₁ is turned on again so that battery voltage V_{b} is applied across phase winding A, which is conducive for current build up. The net energy transferred to phase winding A is equal to the difference between the energy received from battery 2 and the energy delivered to capacitor C. For a machine to continue to generate torque in the CW direction, the energy transferred to the machine winding has to be positive.

Energization of phase winding A from energy stored in capacitor C is designated Mode A2. Turing on transistor Tₐ₂ allows capacitor voltage V_{c} to be applied across phase winding A, resulting in a current through phase winding A. To control the current when it exceeds a set limit, transistor Tₐ₂ is turned off. The current in phase winding A is forced through a current path provided by battery 2 and diode Dₐ₁. The voltage across phase winding A transitions from +V_{c} to −V_{b}, thus forcing the current to decay in phase winding A. Phase winding A current charges battery 2, such that the energy stored in the inductance of phase winding A is transferred to battery 2. When the current in phase winding A falls below an established limit, transistor Tₐ₂ is turned on so as to reverse bias diode Dₐ₁ and transfer phase winding A current to capacitor C, rather than battery 2. The voltage across phase winding A again is +V_{c}, which increases the current in phase winding A. The net energy transferred to phase winding A is the difference between the energy transferred from capacitor C and the energy transferred to battery 2. So long as this net energy is positive, the energy transfer to the machine is positive and some energy is transferred to battery 2 from the energy stored in capacitor C.

Using Modes A1 and A2, phase winding A can be energized in a controlled manner and receive energy from either battery 2 or capacitor C. When energy is transferred from battery 2 to the machine, a part of the energy is also transferred to capacitor C via phase winding A; and when the energy is transferred from capacitor C to phase winding A, a part of the energy stored by capacitor C is transferred to battery 2 via phase winding A. In a battery-operated motor drive for an electric-vehicle (EV) application, where the energy supply has to come from a battery pack, as it is the only source of energy, it is important to realize that Mode A1 is the most dominant mode, but Mode A2 is a secondary mode that serves to send energy recovered during Mode A1 to a machine winding and the battery pack itself.

Some distinct features of the above-described circuit controlling phase winding A are:
(i) Currents of alternating polarity in phase winding A.
(ii) Energy transfer from battery 2 to phase winding A and then from phase winding A to storage capacitor C.
(iii) Energy transfer from storage capacitor C to phase winding A and then from phase winding A to battery 2.
(iv) Only one transistor or a diode is conducting at any given time, in this part of the circuit, resulting in high-efficiency operation of the converter subsystem, which contributes to the high overall system efficiency of the motor drive system.
(v) Transistor Tₐ₁ and diode Dₐ₁ can be in one package and transistor Tₐ₂ and diode Dₐ₂ can be in one package, so as to achieve some compactness in the converter using packaging that is readily available commercially.
(vi) Transistor Tₐ₁, diode Dₐ₁, transistor Tₐ₂, and diode Dₐ₂ can be realized in the form of a single phase leg of an inverter, within an integral package, for greater compactness.

Energization of phase winding B by battery 2 is designated Mode B1. Turing on transistor T_{b1} will apply battery voltage V_{b} across phase winding B, which will establish a current in phase winding B that generates torque in the machine, say, in the CW direction and, hence, moves the rotor in the CW direction. If phase winding B current exceeds a set limit, transistor T_{b1} may be turned off, which will cut off battery voltage V_{b} to phase winding B. As the current is nonzero at the turn-off time of T_{b1}, there is energy storage in the inductance of phase winding B. The energy stored in the inductance of phase winding B must be transferred to a source or result in a high rise of voltage across transistor T_{b1}. The only manner in which the energy in phase winding B can be transferred is through the flow of current through diode D_{b2} and capacitor C, resulting in an increase of voltage across capacitor C. The voltage of capacitor C is also applied across phase winding B and has a polarity that is conducive for current decay, not for build-up, as the current is charging capacitor C and flowing against capacitor voltage V_{c}. When the current falls below the set limit, so as to maintain current at a desired level, transistor T_{b1} is turned on again so that battery voltage V_{b} is applied across phase winding B, which is conducive for current build up. The net energy transferred to phase winding B is equal to the difference between the energy received from battery 2 and the energy delivered to capacitor C. For a machine to continue to generate torque in the CW direction, the energy transferred to the machine winding has to be positive.

The energy stored in capacitor C cannot be used to energize phase winding B. In battery operated motor drives, most of the energy to power the motor drive has to come from the battery and the energy stored in the capacitor, due to commutation of the phase windings, may not be enough to feed two phases. Therefore, there may be no need to have the converter arrangement as employed with phase winding A. Transistor T_{b1} and diode D_{b2} may be sufficient to handle phase winding B, resulting in a saving of devices, control circuits, and associated logic power supply requirements.

Distinct features of the phase winding B circuit are:
(i) Phase winding B conducts only unidirectional current, not bidirectional current as in the case of phase winding A.
(ii) Phase winding B draws energy from battery 2, and part of the energy stored in phase winding B is transferred to storage capacitor C.
(iii) Phase winding B cannot receive energy from storage capacitor C.
(iv) The circuit for phase winding B operation requires only one transistor and one diode.
(v) The transistor and diode can be packaged in one piece as a readily available chopper module. Such use of a chopper module leads to less assembly error in the electronics subsystem of the drive system, resulting in higher reliability of the electronics, compact packaging of the converter, and possible overall cost reduction in the electronics subsystem.

The principles of the two-phase SRM can be applied to a multiphase SRM having greater than two phases. A generalized embodiment of a multiphase SRM is presented.

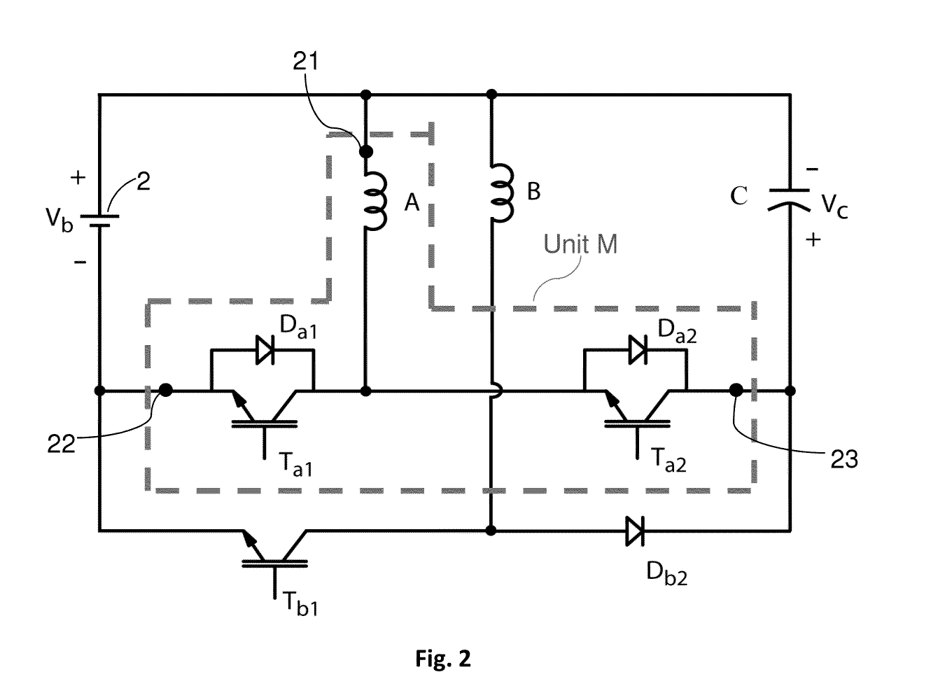

FIG. 2 illustrates a modular unit M within the power converter of FIG. 1. Unit M comprises the above-described phase winding A and its related electronics of transistors Tₐ₁ and Tₐ₂ and diodes Dₐ₁ and D. Unit M is a three terminal device. A terminal 21 is connected to one end of phase winding A, a terminal 22 is connected to the emitter of transistor Tₐ₁ and anode of diode Dₐ₁, and a terminal 23 is connected the collector of transistor Tₐ₂ and cathode of diode Dₐ₂. The other end of phase winding A is connected to the collector of transistor Tₐ₁, cathode of diode Dₐ₁, emitter of transistor Tₐ₂, and anode of diode Dₐ₂. Thus, unit M has three external terminals 21, 22, and 23. To realize its operation, unit M's terminal 21 is connected to the positive terminal of battery 2 and capacitor C's terminal identified by symbol “−.” Terminal 22 is connected to the negative terminal of battery 2, and terminal 23 is connected to the capacitor C's terminal identified by symbol “+.”

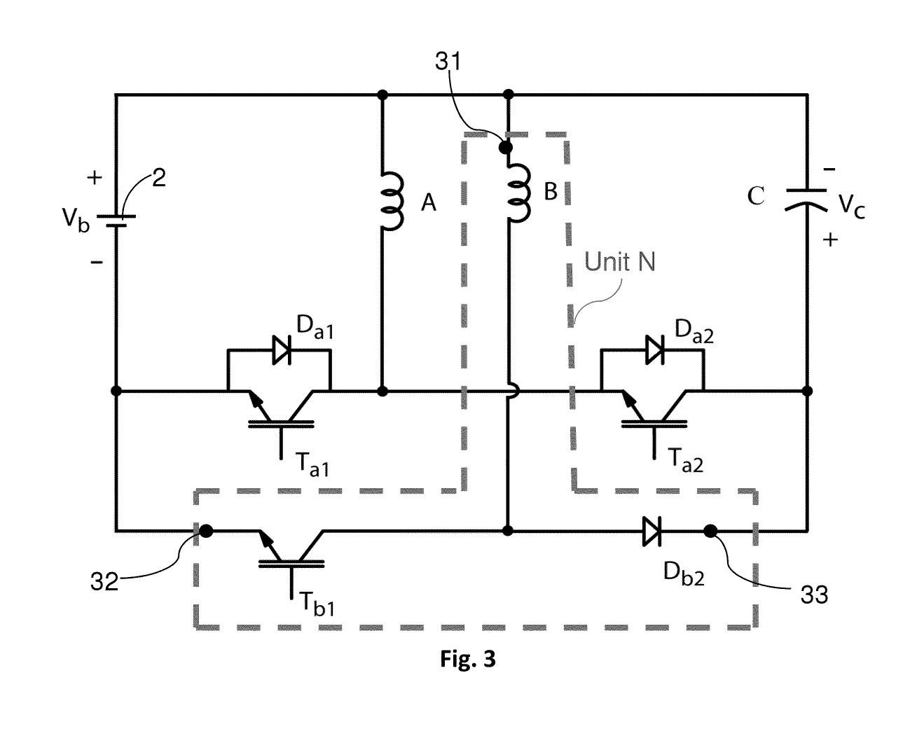

FIG. 3 illustrates a modular unit N within the power converter of FIG. 1. Unit N comprises the above-described phase winding B and its related electronics of transistor T_{b1} and diode D_{b2}. Unit N is a three terminal device. A terminal 31 is connected to one end of phase winding B, a terminal 32 is connected to the emitter of T_{b1}, and a terminal 33 is connected to the cathode of diode D_{b2}. The other end of phase winding B is connected to the collector of transistor T_{b1} and anode of diode D_{b2}. Thus, unit N has three external terminals 31, 32, and 33. To realize its operation, unit N's terminal 31 is connected to the positive terminal of battery 2 and the terminal of capacitor C identified by symbol “−.” Terminal 32 is connected to the negative terminal of battery 2, and terminal 33 is connected to the terminal of capacitor C identified by symbol “+.”

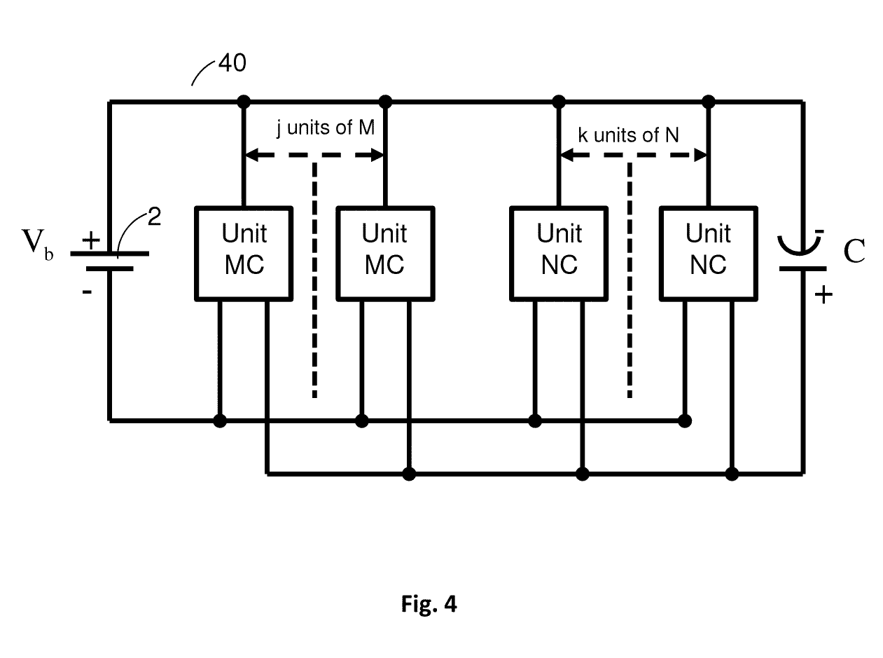

FIG. 4 illustrates an embodiment of a power converter having any number of machine phases. Consider a machine having an integer number, h, of phases. Of these, j phases need to have energy supplied from battery 2 for some time and from a storage capacitor C for some time. Let j be less than h and k=h−j. In such a case, k phases have energy supplied only by battery 2. Thus, j unit Ms and k unit Ns are integrated with battery 2 and storage capacitor C in a power converter 40. The selection of integer values j and k is one of design based on application and cost requirements.

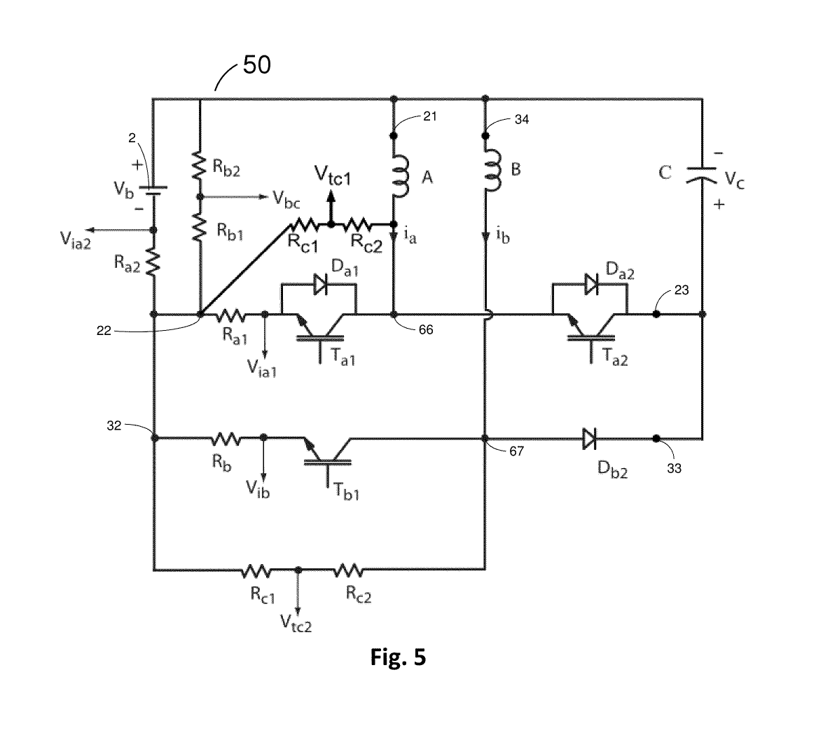

FIG. 5 illustrates an embodiment of the power converter illustrated by FIG. 1 having voltage and current sensors. FIG. 5 differs from FIG. 1 in the addition of such sensors. The addition of the sensors enables current and voltage measurements to be made for use in feedback control of a power converter 50 and, therefore, in the feedback control of the SRM. Battery pack 2 is connected to phase winding A through transistor Tₐ₁ and two current sensing resistors Rₐ₁ and Rₐ₂. To sense the voltage of battery 2, a potential divider comprising two resistors R_{b1} and R_{b2} is connected across battery 2's positive terminal and terminal 22. Likewise, to measure the potential between terminal 22 and a terminal 66, a potential divider comprising resistors R_{c1} and R_{c2} is connected across terminals 66 and 22.

The current flowing through transistor Tₐ₁ or diode Dₐ₁ is measured by the voltage drop across resistor Rₐ₁ at the tap for a voltage signal Vᵢₐ₁. This voltage, which is equal to the current flowing through resistor Rₐ₁ multiplied by the resistance of resistor Rₐ₁, is with reference to terminal 22. Similarly, the current flowing through battery 2, which current is the same as that flowing through diode Dₐ₁ or transistor Tₐ₁, is also measured by the voltage drop across resistor Rₐ₂ at the tap for a voltage signal Vᵢₐ₂. The voltage of battery 2 is measured by tapping a voltage signal V_{bc}, which is available at the junction of resistors R_{b1} and R_{b2}. The accuracy of the battery voltage measurement is not compromised by the voltage drop across current sensing resistor Rₐ₂, because this voltage drop is negligible compared to the battery voltage. Similarly, the voltage across terminals 66 and 22 is given by tapping a voltage signal V_{tc1}.

Similar insertion of a current resistor and resistors for voltage sensing is done for phase winding B. The current flowing through phase winding B and transistor T_{b1} is determined from the voltage drop across a resistor R_{b}, which is inserted between the emitter of transistor T_{b1} and terminal 22. A voltage signal V_{ib} indicates the current in transistor T_{b1}, according to the relation of voltage signal V_{1b} equals the current flowing through phase winding B multiplied by the resistance of resistor R_{b}. A voltage signal V_{tc2} across terminals 32 and 67 is measured using a potential divider comprising resistors R_{c1} and R_{c2}, and voltage signal V_{tc2} is with respect to terminal 22.

Three modes of operation for phase winding A are described.

Mode 1: Phase winding A current flows from terminal 21 to terminal 66, which is considered a positive current hereafter. The current in phase winding A, when transistor Tₐ₁ is turned on, is positive and represented by voltage signal Vᵢₐ₁. Voltage signal Vᵢₐ₁ is positive for this condition with respect to terminal 22. While transistor Tₐ₁ is on, voltage signal V_{tc1} indicates transistor Tₐ₁'s conduction voltage, which may not be of interest in a control system during this mode of operation. Phase winding A's current signal is derived as follows:

Vᵢₐ₁−iₐRₐ₁, (1)

where iₐ is the phase winding A current. From equation 1, the current in phase winding A is derived as:

$${i}_{a} = \frac{{V}_{ia 1}}{{R}_{a 1}} . \qquad ( 2 )$$

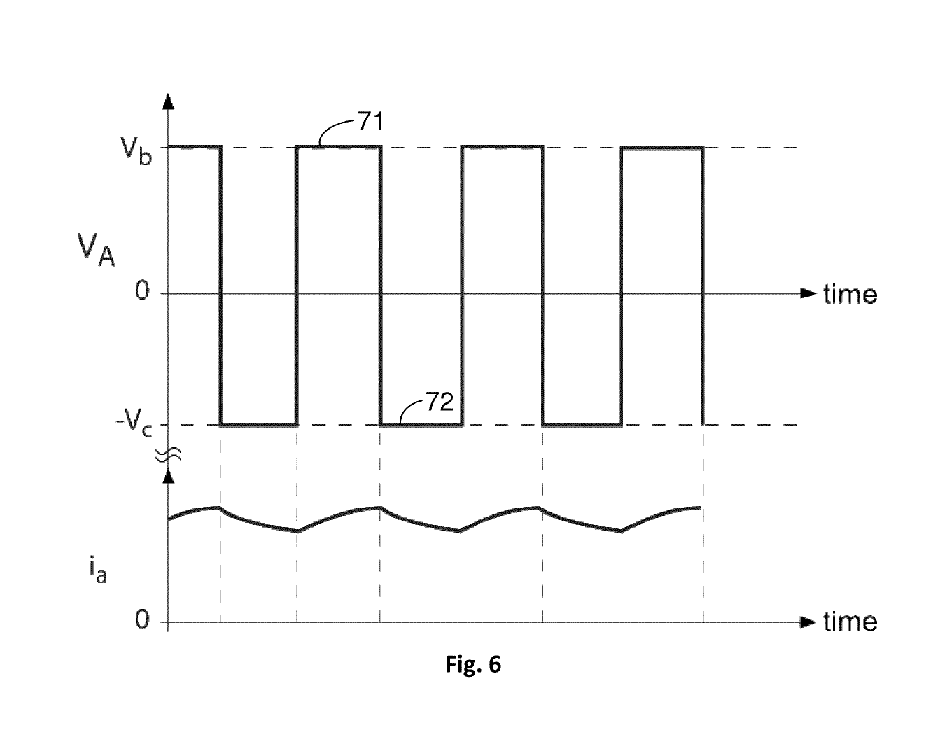

FIG. 6 illustrates, for the power converter of FIG. 5, the relation of current iₐ in phase winding A and a voltage V_{A} across phase winding A. When transistor Tₐ₁ is on, during a time period 71, the voltage across phase winding A is V_{b}. In period 71, current iₐ increases with time, because battery voltage V_{b} is continuously applied to phase winding A. During a period 72 that transistor Tₐ₁ is turned off at the end of period 71, diode Dₐ₂ conveys current so as to discharge energy stored in phase winding A into capacitor C. During period 72, current iₐ decreases, as energy from phase winding A is supplying capacitor C and voltage V_{A} equals −V_{c}, where V_{c} is positive with respect to terminal 21 of phase winding A.

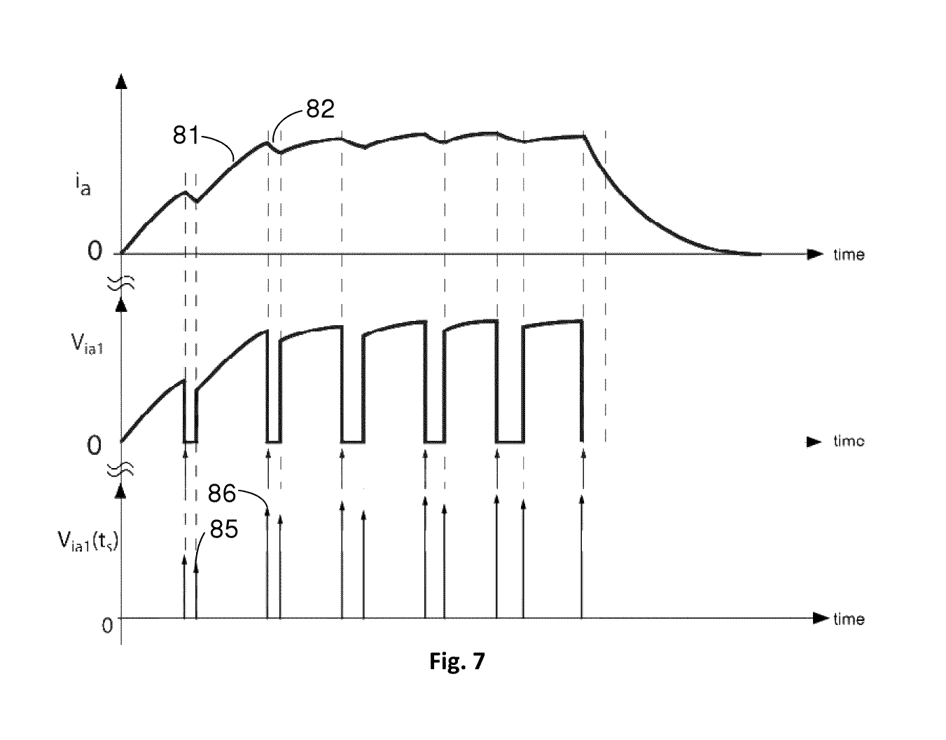

FIG. 7 illustrates, for the power converter of FIG. 5, phase winding A current iₐ, voltage signal Vᵢₐ₁, and a sampling of voltage signal Vᵢₐ₁, identified by Vᵢₐ₁(tₛ), with respect to time for Mode 1 operation. Phase winding A current iₐ is shown for one phase conduction period, and the current follows a rectangular current reference, as is common in SRM drives. During a period 81, transistor Tₐ₁ is turned on and current iₐ and voltage signal Vᵢₐ₁ increase. During a period 82, transistor Tₐ₁ is turned off and current iₐ decreases and voltage signal Vᵢₐ₁ is zero. Current iₐ and voltage signal Vᵢₐ₁ have similar waveforms during period 81, though each is scaled by the resistance value of Rₐ₁ with respect to the other. Voltage signal Vᵢₐ₁ has a value of zero in period 82, because no current flows through resistor Rₐ₁ during the non-conduction period of transistor Tₐ₁.

The waveform of current iₐ, illustrated in FIG. 7, occurs in one pulse width modulation (PWM) cycle. For feedback control purposes, an average value is desired for each PWM cycle. The average value can be obtained in many ways, such as by taking an average value of the beginning and the ending values of the conduction period only. Samples of voltage signal Vᵢₐ₁ may be taken at the turn-on and turn-off instances 85, 86 of transistor Tₐ₁ and averaged to provide a fairly accurate value of the average phase current for phase winding A. The algorithm can be more refined depending on the accuracy required for an application.

Mode 2: When transistor Tₐ₁ is turned off, with current in phase winding A, the flow of current will transfer from transistor Tₐ₁ to diode Dₐ₂ and capacitor C, so as to charge capacitor C through a closed circuit with phase winding A. Ignoring the voltage drop across diode Dₐ₂, the voltage across phase winding A is equal to the capacitor voltage V_{c}, with its positive terminal being terminal 66 with respect to terminal 21. Therefore, the voltage across terminals 22 and 66 is equal to the sum of battery voltage V_{b} and capacitor voltage V_{c} and is obtained by ignoring the resistance of resistor Rₐ₁ relative to the values of resistors R_{c1} and R_{c2}. Voltage signal V_{tc1} is determined from a current iₛᵥ₁ that flows in resistors R_{c1} and R_{c2}. Current iₛᵥ₁ is expressed by:

$${i}_{sv 1} = \frac{{V}_{b} + {V}_{c}}{{R}_{c 1} + {R}_{c 2}} . \qquad ( 3 )$$

Therefore, voltage signal V_{tc1} is derived as:

$$\begin{matrix}{V}_{tc 1} = {i}_{sv 1} {R}_{c 1} \\ = \frac{{R}_{c 1}}{{R}_{c 1} + {R}_{c 2}} ( {V}_{b} + {V}_{c} ) .\end{matrix} \qquad ( 4 )$$

A voltage signal V_{bc}, which indicates the voltage of battery 2, is determined by similar reasoning. A current iₛᵥ₂ in resistors R_{b1} and R_{b2} is derived as:

$${i}_{sv 2} = \frac{{V}_{b}}{{R}_{b 1} + {R}_{b 2}} , \qquad ( 5 )$$

from which voltage signal V_{bc} is derived as:

$$\begin{matrix}{V}_{bc} = {i}_{sv 2} {R}_{b 1} \\ = \frac{{R}_{b 1}}{{R}_{b 1} + {R}_{b 2}} {V}_{b} .\end{matrix} \qquad ( 6 )$$

From equation 6, battery voltage V_{b} is derived in terms of voltage signal V_{bc} as:

$${V}_{b} = \frac{{R}_{b 1} + {R}_{b 2}}{{R}_{b 1}} {V}_{bc} . \qquad ( 7 )$$

Similarly, from equation 2, the sum of the voltages of battery 2 and capacitor C is derived as:

$${V}_{b} + {V}_{c} = \frac{{R}_{c 1} + {R}_{c 2}}{{R}_{c 1}} {V}_{tc 1} . \qquad ( 8 )$$

From equations 7 and 8, capacitor voltage V_{c} is found as:

$$\begin{matrix}{V}_{c} = \frac{{R}_{c 1} + {R}_{c 2}}{{R}_{c 1}} {V}_{tc 1} - {V}_{b} \\ = \frac{{R}_{c 1} + {R}_{c 2}}{{R}_{c 1}} {V}_{tc 1} - \frac{{R}_{b 1} + {R}_{b 2}}{{R}_{b 1}} {V}_{bc} .\end{matrix} \qquad ( 9 )$$

Equation 9 shows that capacitor voltage V_{c} is a function of voltage signal V_{bc} and voltage signal V_{tc1}. Capacitor voltage V_{c} is measured when phase winding A is charging capacitor C. Battery voltage signal V_{bc} is available all the time, whether phase winding A is being charged by battery 2 or capacitor C.

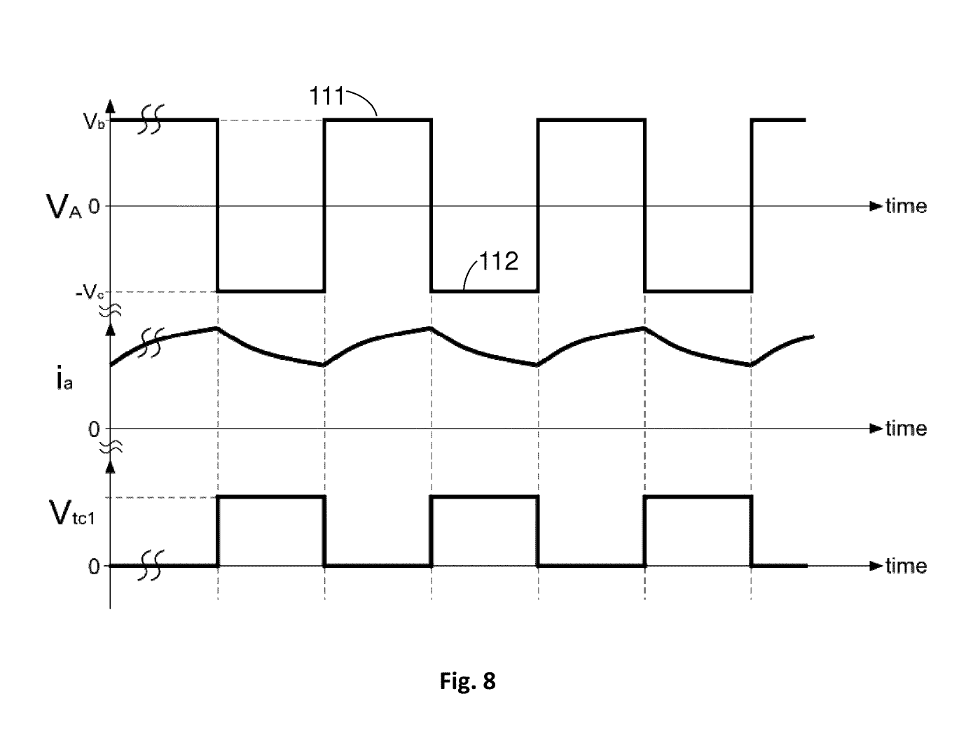

FIG. 8 illustrates, for the power converter of FIG. 5, voltage signal V_{tc1} relative to voltage V_{A} across phase winding A and current iₐ flowing through phase winding A for Mode 2 operation. A PWM cycle comprises periods 111 and 112. During period 111, transistor Tₐ₁ is turned on so that battery voltage V_{b} is applied across phase winding A and current iₐ increases. During period 112, transistor Tₐ₁ is turned off so that capacitor voltage V_{c} is applied across phase winding A and current iₐ decreases. When transistor Tₐ₁ is turned on, the voltage across terminals 22 and 66 is almost equal to the conduction voltage drop of transistor Tₐ₁, which conduction voltage drop is small compared to either battery voltage V_{b} or capacitor voltage V_{c} and, therefore, is treated as equal to zero in FIG. 8. When transistor Tₐ₁ is turned off, the voltage applied across phase A is equal to capacitor voltage V_{c}. Therefore, the voltage across terminals 22 and 66 is approximately equal to the sum of battery voltage V_{b} and phase winding A voltage V_{A}, which is equal to V_{c}. Voltage signal V_{tc1} provides a scaled representation of the voltage across terminals 22 and 66.

Mode 3: The scenario of energy recovery from storage capacitor C, via the energization of phase winding A with transistor Tₐ₂, is considered. When transistor Tₐ₂ is turned on, storage capacitor voltage V_{c} is applied to phase winding A, with terminal 66 being positive with respect to terminal 21. Current iₐ flows from terminal 66 to terminal 21 in phase winding A and through capacitor C and transistor Tₐ₂. By this adopted convention, current iₐ in phase winding A is negative.

Current iₐ is derived as follows. Phase winding A current iₐ is measured for an instant, by turning off transistor Tₐ₂ for a short interval of time or during its turn-off time in a PWM switching cycle, during which time current iₐ will transfer from transistor Tₐ₂ to diode Dₐ₁ via phase winding A, battery pack 2, resistor Rₐ₂, and resistor Rₐ₁.

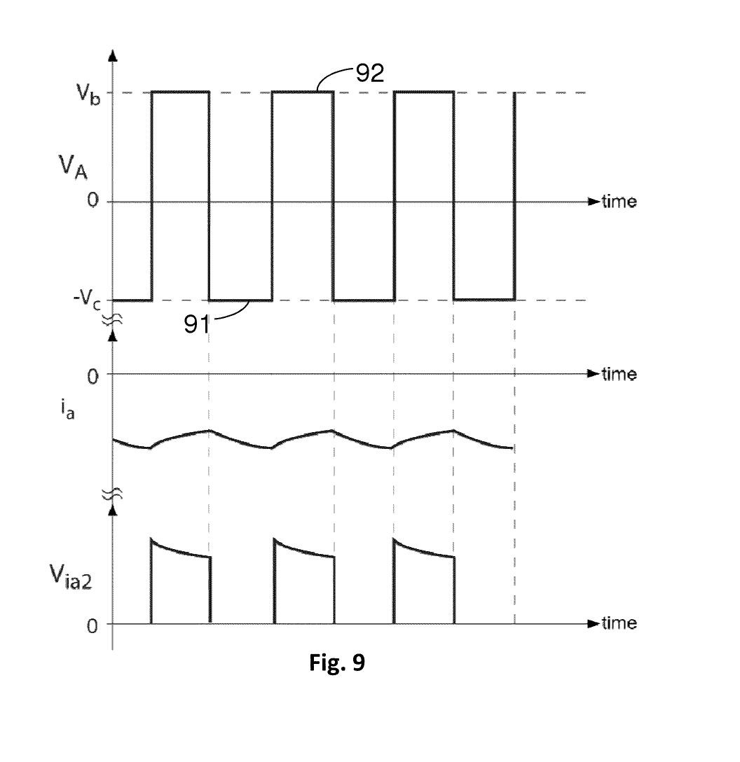

FIG. 9 illustrates, for the power converter of FIG. 5, voltage signal Vᵢₐ₂ relative to voltage V_{A} across phase winding A and current iₐ flowing through phase winding A for Mode 3 operation. A PWM cycle comprises periods 91 and 92. During period 91, transistor Tₐ₂ is turned on, the magnitude of voltage V_{A} across phase winding A is the same as capacitor voltage V_{c}, phase winding A current iₐ decreases, and voltage signal Vᵢₐ₁ is zero. Neither transistor Tₐ₁ nor diode Dₐ₁ conducts current during period 91.

During period 92, transistor Tₐ₂ is turned off so that current iₐ from phase winding A goes through battery 2, resistors Rₐ₂ and Rₐ₁, and diode Dₐ₁. The voltage drop, represented by voltage signal Vᵢₐ₂, across resistor Rₐ₂ with respect to terminal 22 is positive. Voltage V_{A} applied across phase winding A during period 92 is equal to battery voltage V_{b}, ignoring the resistive voltage drop across resistors Rₐ₁ and Rₐ₂, phase winding current iₐ is increasing, and voltage signal Vᵢₐ₁ is positive with a decreasing value over time. Voltage signal Vᵢₐ₁ provides a scaled representation of battery voltage V_{b}.

Voltage signal Vᵢₐ₁ can be negative for Mode 3 operation, when transistor Tₐ₂ is turned off. It is preferable for sensor signals to provide positive values; therefore, voltage signal Vᵢₐ₂ is used during Mode 3. Voltage signal Vᵢₐ₂ is positive with respect to terminal 22 and is equal to phase winding A current iₐ multiplied by the resistance of resistor R. Voltage signal Vᵢₐ₂ is given by:

Vᵢₐ₂=iₐRₐ₂, (10)

where current iₐ is the current flowing through phase winding A. Current iₐ is derived from the measured voltage signal Vᵢₐ₁ as:

$${i}_{a} = \frac{{V}_{ia 2}}{{R}_{a 2}} . \qquad ( 11 )$$

After measuring voltage signal Vᵢₐ₂ for an instant, phase winding A can again be energized from storage capacitor C, by turning on transistor Tₐ₂.

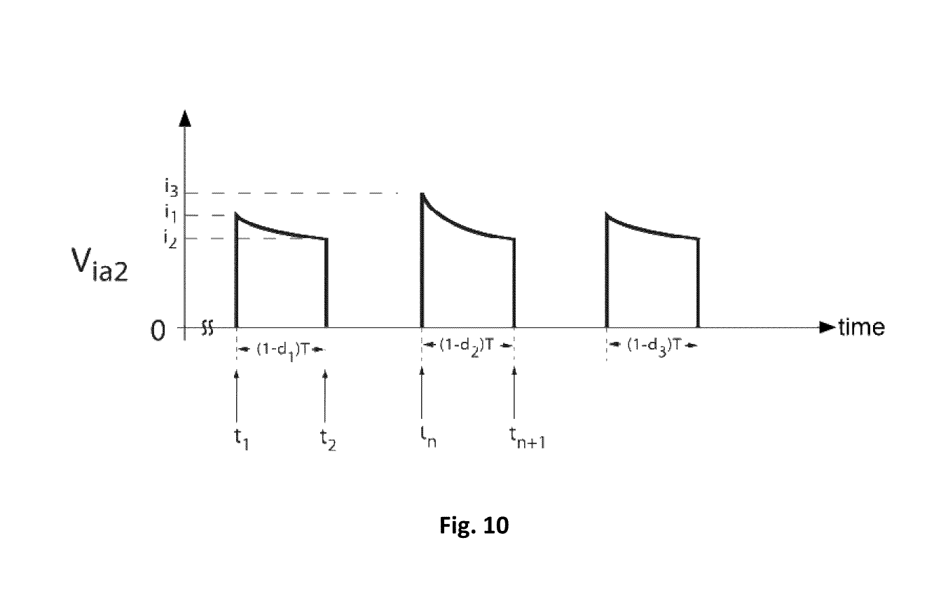

FIG. 10 illustrates signal voltage Vᵢₐ₂ within FIG. 9 in greater detail. The instantaneous value of current iₐ in phase winding A at a moment t₁, when transistor Tₐ₂ is turned off, is indicated by i₁. Between moments t₁ and t₂, voltage signal Vᵢₐ₁ has a decreasing value and the instantaneous value of current iₐ at time t₂ is indicated by i₂. At moment t₂, transistor Tₐ₂ is turned on again and maintained in the on condition until moment tₙ, where the instantaneous value of current iₐ is indicated by i₃ and transistor tₐ₂ is turned off again.

Between moments t₂ and tₙ, voltage signal Vᵢₐ₂ is zero and current iₐ is not sensed. Instead, for Mode 3, current is sensed only when transistor Tₐ₂ is turned off and diode Dₐ₁ conducts current. This does not a create a problem in control, as most of the time an average signal is all that is required for feedback control. An average can be obtained for the period between moments t₁ and t₂ by taking an average of the currents iₐ at those moments. Similarly, an average current between moments tₙ and tₙ₊₁ can be obtained. If the current average is desired for the interval during transistor Tₐ₂'s conduction, such as between moments t₂ and tₙ, then it is obtained as the average of the currents iₐ at the instances of t₂ and tₙ, which is the average of currents i₂ and i₃.

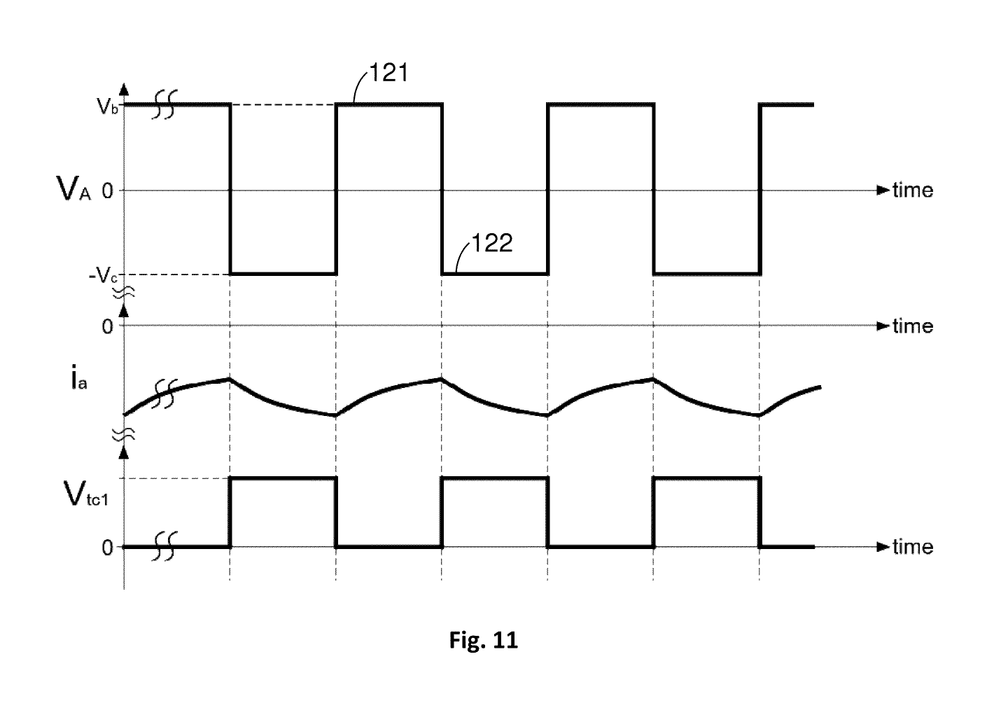

FIG. 11 illustrates, for the power converter of FIG. 5, voltage V_{A} across phase winding A, phase winding A current iₐ, and voltage signal V_{tc1} with respect to time for Mode 3 operation. A PWM cycle includes periods 121 and 122. During transistor Tₐ₂'s period of non-conduction, voltage V_{A} applied across phase winding A, assuming there has been a current previously from capacitor C via transistor Tₐ₂ into phase winding A, amounts to battery voltage V_{b}. Voltage V_{A} is considered positive, meaning terminal 21 is positive relative to terminal 66. During time period 121, the corresponding phase winding A current iₐ increases and voltage signal V_{tc1} is zero. More specifically, the rate at which phase winding A current iₐ increases declines as the energy stored in phase winding A charges battery 2. Signal voltage V_{tc1} is zero because diode Dₐ₁ is conducting and its voltage drop is negligible. The voltage drop across diode Dₐ₁ is reflected across resistors R_{c1} and R_{c2}.

When transistor Tₐ₂ is on, voltage V_{A} across phase winding A is −V_{c}, that is from terminal 21 to terminal 66. Ignoring resistor Rₐ₂, the voltage across resistors R_{c1} and R_{c2} is equal to the sum of battery voltage V_{b} and capacitor voltage V_{c}. Accordingly, voltage signal V_{tc1} is a scaled version of the sum of voltages V_{b} and V_{c}, as expressed by Equation 4.

Phase B operation of the SRM drive has only two modes, which are similar to Mode 1 and Mode 2 of phase winding A.

Mode 1: A current i_{b} in phase winding B, when transistor T_{b1} is turned on, is obtained from voltage signal V_{ib}. Voltage signal V_{ib} is positive for this condition, with respect to terminal 22. Voltage signal V_{tc2} indicates transistor T_{b1}'s conduction voltage. Phase winding B current signal i_{b} is derived as follows:

V_{ib1}=i_{b}R_{b}. (12)

From equation 12, current i_{b} in phase winding B is derived as:

$${i}_{b} = \frac{{V}_{ib}}{{R}_{b}} . \qquad ( 13 )$$

Mode 2: When transistor T_{b1} is turned off with current in phase winding B, current i_{b} will transfer from transistor T_{b1} to diode D_{b2}, resulting in the charging of capacitor C and the closing of a circuit via phase winding B. Ignoring the voltage drop across diode D_{b2}, the voltage across phase winding B is equal to capacitor voltage V_{c}, from the perspective of terminal 67 relative to a terminal 34. Therefore, the voltage across terminals 32 and 67 is equal to the sum of battery voltage V_{b} and capacitor voltage V_{c} and is obtained by ignoring the resistance of resistor Rₐ₂, relative to the values of resistors R_{c1} and R_{c2}. Voltage signal V_{tc2} is found from a current iₛᵥ₂ that flows in resistors R_{c1} and R_{c2}, and current iₛᵥ₂ is expressed as:

$${i}_{sv 2} = \frac{{V}_{b} + {V}_{c}}{{R}_{c 1} + {R}_{c 2}} . \qquad ( 14 )$$

Therefore, voltage signal V_{tc2} is derived as:

$$\begin{matrix}{V}_{tc 2} = {i}_{sv 2} {R}_{c 1} \\ = \frac{{R}_{c 1}}{{R}_{c 1} + {R}_{c 2}} ( {V}_{b} + {V}_{c} ) .\end{matrix} \qquad ( 15 )$$

The state of battery voltage V_{b} is indicated by voltage signal V_{bc} and obtained by similar reasoning. A current iₛᵥ₂ in resistors R_{b1} and R_{b2} is:

$${i}_{sv 2} = \frac{{V}_{b}}{{R}_{b 1} + {R}_{b 2}} , \qquad ( 16 )$$

from which battery voltage signal V_{bc} is derived as:

$$\begin{matrix}{V}_{bc} = {i}_{sv 2} {R}_{b 1} \\ = \frac{{R}_{b 1}}{{R}_{b 1} + {R}_{b 2}} {V}_{b} .\end{matrix} \qquad ( 17 )$$

From equation 17, V_{b} is derived in terms of V_{bc} as

$${V}_{b} = \frac{{R}_{b 1} + {R}_{b 2}}{{R}_{b 1}} {V}_{bc} . \qquad ( 18 )$$

Similarly, from equation 13, the sum of battery voltage V_{b} and capacitor voltage V_{c} is derived as

$${V}_{b} + {V}_{c} = \frac{{R}_{c 1} + {R}_{c 2}}{{R}_{c 1}} {V}_{tc 2} . \qquad ( 19 )$$

From equations 18 and 19, capacitor voltage V_{c} is found as:

$$\begin{matrix}{V}_{c} = \frac{{R}_{c 1} + {R}_{c 2}}{{R}_{c 1}} {V}_{tc 2} - {V}_{b} \\ = \frac{{R}_{c 1} + {R}_{c 2}}{{R}_{c 1}} {V}_{tc 2} - \frac{{R}_{b 1} + {R}_{b 2}}{{R}_{b 1}} {V}_{bc} .\end{matrix} \qquad ( 20 )$$

Equation 20 shows that capacitor voltage V_{c} is expressed as a function of voltage signal V_{bc} and voltage signal V_{tc2}. Capacitor voltage V_{c} is measured only when phase winding B is charging capacitor C. Having determined capacitor voltage V_{c} and battery voltage V_{b}, voltage V_{A} applied across phase winding A, which is either battery voltage V_{b} or capacitor voltage V_{c}, may be determined.

The current in battery 2 is determined from measurements made using the current sensors, one of which gives the incoming and the other gives the outgoing current in battery 2. Machine phase currents iₐ and i_{b} and storage capacitor currents can be derived from current sensor measurements. Wherever measurements cannot be continuously made due to the nature of the circuit, the average currents in a PWM switching cycle may be determined. Such average values over a PWM switching cycle are sufficient for control purposes.

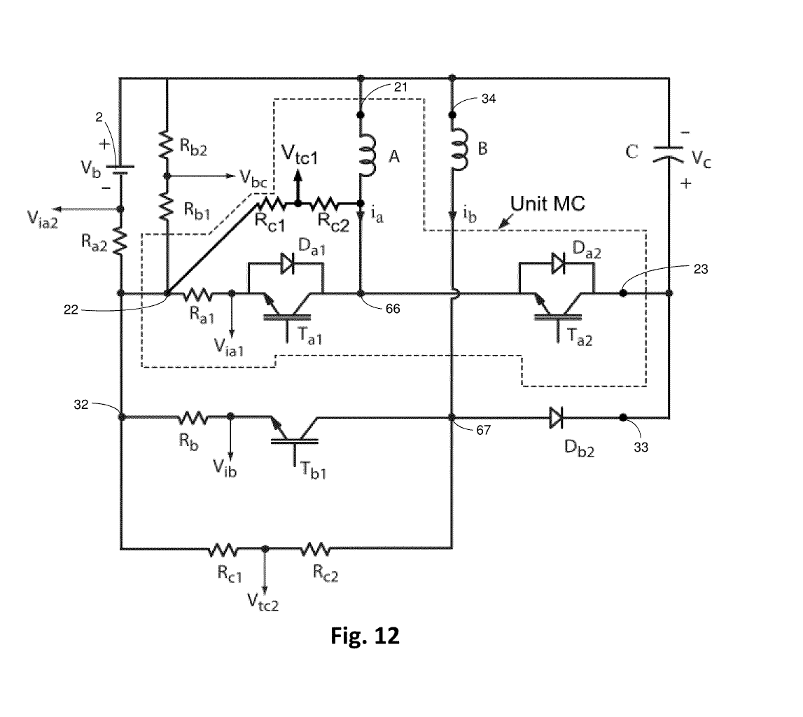

FIG. 12 illustrates the modularization of the phase A circuitry illustrated by FIG. 5. Any number of phase modules MC may exist, with self-contained current sensing and voltage sensing circuits providing out-current signals, such as is provided by voltage signal Vᵢₐ₁, and voltage signals, such as is provided by voltage signal V_{tc1}.

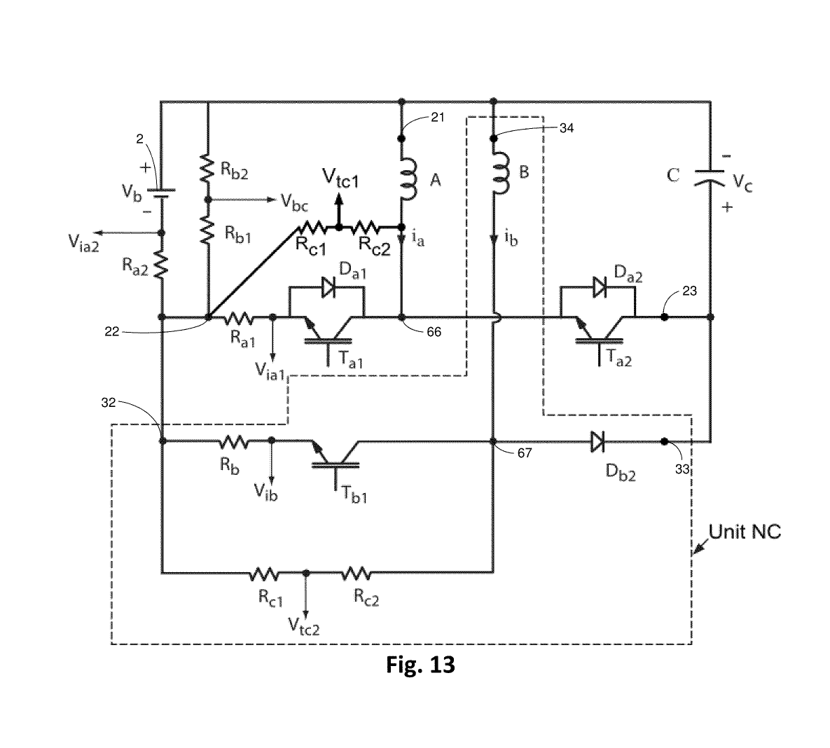

FIG. 13 illustrates the modularization of the phase B circuitry illustrated by FIG. 5. Any number of phase modules NC may exist, with self-contained current sensing and voltage sensing circuits providing out-current signals, such as is provided by voltage signal V_{ib}, and voltage signals, such as is provided by voltage signal V_{tc2}.

Current sensing that occurs while storage capacitor C is charging a phase can be obtained from voltage signal Vᵢₐ₂ across resistor Rₐ₂, and this could be common for the generalized circuit. Similarly, the generalized circuit may also have the potential divider, comprising resistors R_{b1} and R_{b2}, to measure battery voltage V_{b} via voltage signal V_{bc}.

Consider phase winding A, transistor Tₐ₁, diode Dₐ₁, resistors Rₐ₁, R_{c1} and R_{c2}, transistor Tₐ₂, and diode Dₐ₂ enclosed in dotted lines and identified as a unit MC. Unit MC has terminals, 21, 22, and 23. Similarly, a unit NC comprising transistor T_{b1}, current sensing resistor R_{b}, voltage sensing resistors R_{c1} and R_{c2}, phase winding B, and diode Db2 is a three terminal unit having terminals 32, 33, and 34.

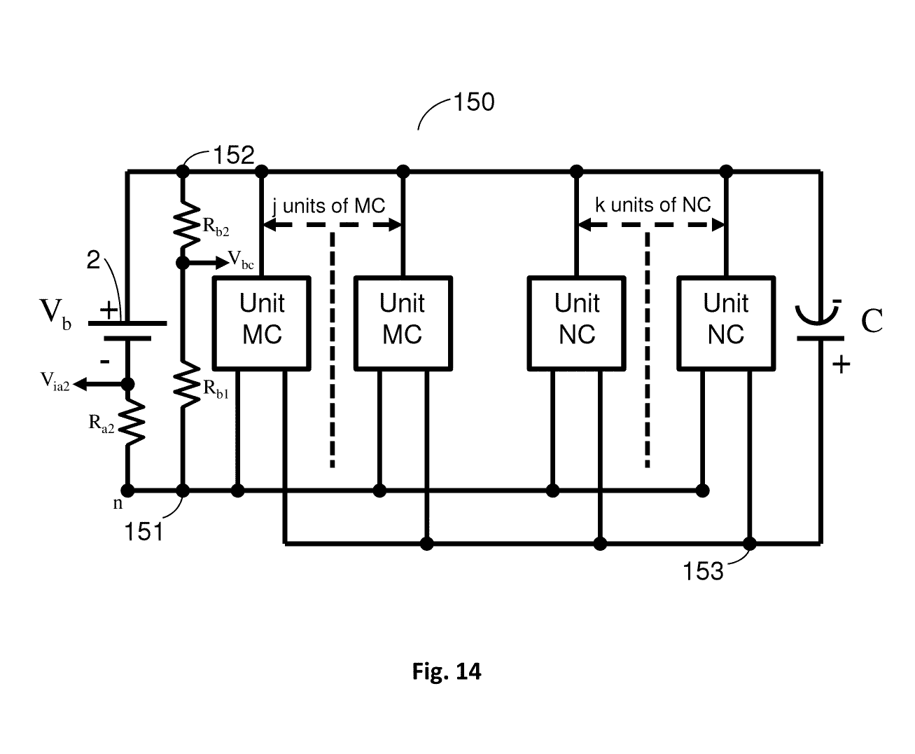

FIG. 14 illustrates an SRM having multiples ones of the phase units illustrated in FIGS. 12 and 13. A power converter 150 includes: (1) battery 2, (2) capacitor C, (3) sensing resistor Rₐ₂, to measure current when energy from capacitor C is transferred to phase winding A, (4) a common potential divider comprising resistors R_{b1} and R_{b2} to measure battery voltage V_{b} via voltage signal V_{bc}, (5) j units MC connected between terminals 151, 152, and 153, where j is a desired number of phase windings A, and (6) k units NC connected between terminals 151, 152, and 153, where k is a desired number of phase windings B. Unit MC's terminals 151, 152, and 153 correspond to, for example, terminals 22, 21, and 23 in FIG. 12. Likewise, unit NC's terminals 151, 152, and 153 correspond to terminals 32, 34, and 33 in FIG. 12. Parameters j and k are any positive integer values. It is possible to have an equal number of units MC and units NC or zero units NC.

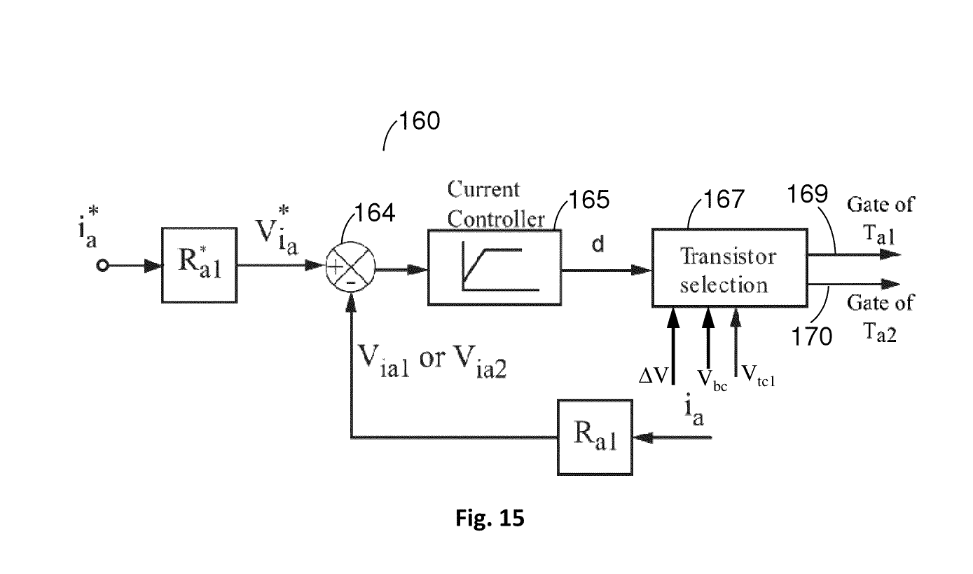

FIG. 15 illustrates a control system for controlling the power converter illustrated by FIG. 14. Phase winding A draws energy from battery 2 or storage capacitor C. For one phase conduction period, only one of battery 2 and storage capacitor C provides energy to phase winding A. The selection of the source determines which of transistors Tₐ₁ and Tₐ₂ conducts. For Mode 1 of phase A operation, current iₐ flowing through resistor Rₐ₁ produces voltage signal Vᵢₐ₁. A current command iₐ*, corresponding to current iₐ, is translated to a voltage Vᵢₐ,* corresponding to Vᵢₐ₁, by flowing through a resistor Rₐ₁ whose resistance is the same as that of resistor Rₐ₁. Since feedback current iₐ and reference current iₐ* are represented in the form of voltages, the difference between the reference and feedback current signals can be obtained by subtraction of their representative voltages using a summer 164, whose output is fed to a current controller 165 of control system 160. Current controller 165 may be a proportional-plus-integral controller or similar device. The output of current controller 165 provides a duty cycle signal d for transistor Tₐ₁ or Tₐ₂. Duty cycle d is limited by current controller 165 to a maximum magnitude of one and a minimum magnitude of zero.

A transistor selection block 167 selects which of transistors Tₐ₁ and Tₐ₂ to turn on, so as to determine which of energy sources, battery 2 and capacitor C, will energize phase winding A for a particular phase cycle. Transistor selection block 167 receives duty cycle signal d, voltage signals V_{tc1} and V_{bc}, and a voltage signal ΔV indicating the allowable voltage change across storage capacitor C. The output of transistor selection block 167 provides control signals to the gates of bipolar junction transistors Tₐ₁ and Tₐ₂. The selection of which transistor conducts during the phase cycle is based on whether voltage signal ΔV exceeds an allowable limit over battery voltage V_{b}, which is represented by voltage signal V_{bc}. Control system 160 may be implemented by a computer processor or programmable logic device.

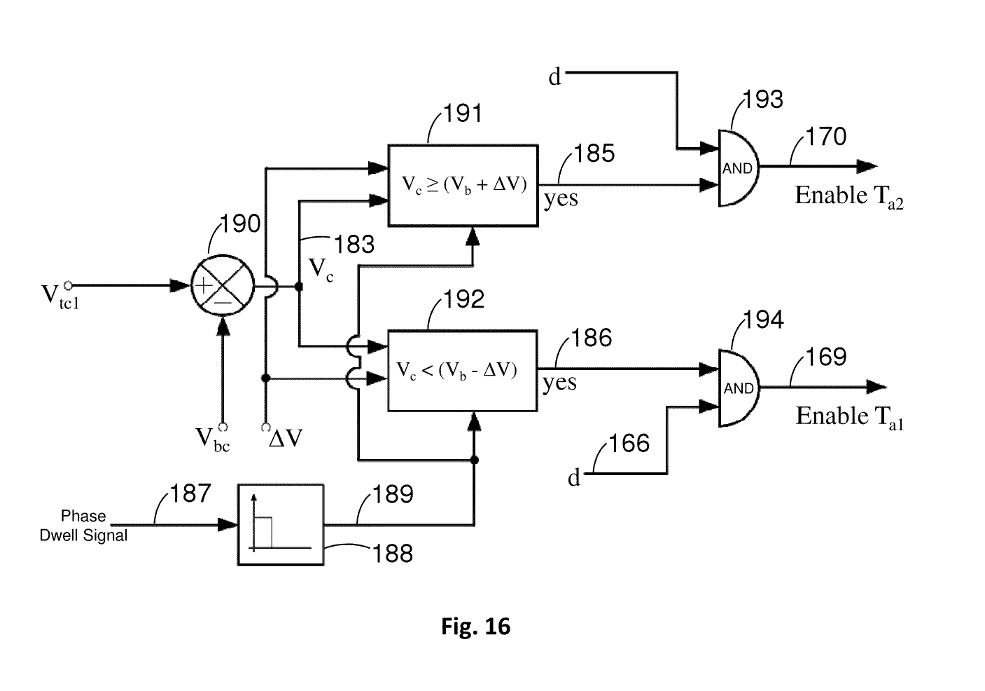

FIG. 16 illustrates the operation of the transistor selection block illustrated in FIG. 15. A summer 190 subtracts voltage signal V_{bc}, representing battery voltage V_{b}, from voltage signal V_{tc1}, which represents the sum of battery voltage V_{b} and capacitor voltage V_{c}, to obtain a signal 183 representing capacitor voltage Y. Logic function blocks 191 and 192 receive signal 183 representing capacitor voltage V_{c}, voltage signal ΔV, and a phase initiation signal 189, which is derived from the starting edge of a phase dwell signal 187. Phase dwell signal 187 is indicative of an angular duration of conduction for a phase winding, which is generated in a control system for a motor drive and determined by the rotational speed and absolute position of the rotor poles in an SRM. Phase dwell signal 187 may be a rectangular pulse that is processed through a sample and hold circuit 188, so that only the leading edge of the pulse is output as phase initiation signal 189.

A logic function block 191 determines whether signal 183 representing capacitor voltage V_{c} is greater than or equal to the sum of battery voltage V_{b} and voltage signal ΔV. Logic function block 191 outputs a binary signal 185 indicating the determination. The value of signal 185 is held for one phase dwell period in accordance with phase initiation signal 189. Similarly, logic function block 192 determines whether signal 183, representing capacitor voltage V_{c}, is less than the difference between battery voltage V_{b} and voltage ΔV. Logic function block 192 outputs a binary signal 186 indicating the determination. The value of signal 186 is held from the beginning to the end of the phase dwell duration in accordance with phase initiation signal 189. Signal 185 is combined by an AND logic function block 193 with duty cycle signal d to generate a gate signal 170 for transistor T.

When gate signal 170 is positive, capacitor C has enough energy to supply phase winding A. Therefore, when the phase dwell signal comes on, transistor Tₐ₂ is turned on to conduct current. Similarly, signal 186 is combined by an AND function block 194 with duty cycle signal d to generate a gate signal 169 for transistor Tₐ₂. When gate signal 169 is positive, storage capacitor C will not be able to supply sufficient energy to phase winding A. Therefore, energy is supplied by battery 2, by turning on transistor Tₐ₁, via gate signal 169, so as to conduct current.

Control system 160 may similarly control phase B operation using current i_{b} indicated by voltage signal V_{ib} and control phase A and phase B operation using current iₐ indicated by voltage sensor Vᵢₐ₂.

The machine phases discussed herein are those pertaining to switched reluctance machines, but are equally applicable to PMBDC machines. The voltage measurements and estimations described herein are also applicable for control purposes other than the ones described. Such an application is the use of machine-phase voltages and currents for estimating rotor position, via a computation of the phase-flux linkages and estimated phase currents.

The disclosed method(s) may be implemented by instructions stored on a storage medium and executed by a computer processor or programmable logic device.

The foregoing description illustrates and describes one or more preferred embodiments of the invention, but the invention may be used in various other combinations, modifications, and environments. The invention is capable of change or modification, within the scope of the inventive concept, as expressed herein, that is commensurate with the above teachings and the skill or knowledge of one skilled in the relevant art. Accordingly, the description is not intended to limit the invention to the embodiments disclosed herein.

What is claimed is:

1. A power converter comprising:
a capacitive storage element;
first and second switches that each conducts current in a conductive state and does not conduct current in a non-conductive state; and
first and second unidirectional current devices that each conducts current unidirectionally, wherein:
the capacitive storage element, first and second switches, and first and second unidirectional current elements are interconnected such that when interconnected with a direct current (dc) voltage supply and a first phase winding of an electrical machine:
a first operational state exists in which energy is transferred from the dc voltage supply to the first phase winding when the first switch is in the conductive state,
a second operational state exists in which energy stored by the first phase winding during the first operational state is transferred to the capacitive storage element when the first switch is in the non-conductive state,
a third operational state exists in which energy stored by the capacitive storage element is transferred to the first phase winding when the second switch is in the conductive state, and
a fourth operational state exists in which energy stored by the first phase winding during the third operational state is transferred to dc voltage supply when the second switch is in the non-conductive state.

2. The power converter of claim 1, wherein:
current is conducted through the dc voltage supply, the first phase winding, and the first switch during the first operational state,
current is conducted through the first phase winding, the second unidirectional current device, and the capacitive storage element during the second operational state,
current is conducted through the capacitive storage element, the second switch, and the first phase winding during the third operational state, and
current is conducted through the first phase winding, the dc voltage supply, and the first unidirectional current device during the fourth operational state.

3. The power converter of claim 1, wherein current conduction through the first phase winding occurs in opposite directions for the first and fourth operational states.

4. The power converter of claim 1, wherein current conduction through the first phase winding occurs in opposite directions for the second and third operational states.

5. The power converter of claim 3, wherein:
current conduction through the first phase winding occurs in the same direction for the first and second operational states, and
current conduction through the first phase winding occurs in the same direction for the third and fourth operational states.

6. The power converter of claim 4, wherein:
current conduction through the first phase winding occurs in the same direction for the first and second operational states, and
current conduction through the first phase winding occurs in the same direction for the third and fourth operational states.

7. The power converter of claim 1, further comprising:
a third switch that conducts current in a conductive state and does not conduct current in a non-conductive state; and
a third unidirectional current device that conducts current unidirectionally, wherein:
the capacitive storage element, first, second and third switches, and first, second, and third unidirectional current elements are interconnected such that when interconnected with the dc voltage supply, the first phase winding, and a second phase winding of the electrical machine:
a fifth operational state exists in which energy is transferred from the dc voltage supply to the second phase winding when the third switch is in the conductive state,
a sixth operational state exists in which energy stored by the second phase winding during the fifth operational state is transferred to the capacitive storage element when the third switch is in the non-conductive state, and
a seventh operational state exists in which energy stored by the capacitive storage element during the sixth operational state is transferred to the first phase winding when the second switch is in the conductive state.

8. The power converter of claim 7, wherein:
current is conducted through the dc voltage supply, the second phase winding, and the third switch during the fifth operational state,
current is conducted through the second phase winding, the third unidirectional current device, and the capacitive storage element during the sixth operational state, and
current is conducted through the capacitive storage element, the second switch, and the first phase winding during the seventh operational state.

9. The power converter of claim 1, wherein current conduction through the dc voltage supply occurs in opposite directions for the first and fourth operational states.

10. The power converter of claim 1, wherein current conduction through the capacitive storage element occurs in opposite directions for the second and third operational states.

11. A method of operating a power converter, the method comprising:
transferring energy from a direct current (dc) voltage supply to a first phase winding of an electrical machine during a first operational state,
transferring energy stored by the first phase winding during the first operational state to a capacitive storage element during a second operational state,
transferring energy stored by the capacitive storage element to the first phase winding during a third operational state, and
transferring energy stored by the first phase winding during the third operational state to the dc voltage supply during a fourth operational state.

12. The method of claim 11, further comprising:
conducting current through the dc voltage supply, the first phase winding, and a first conductive switch during the first operational state,
conducting current through the first phase winding, a first unidirectional current device, and the capacitive storage element during the second operational state,
conducting current through the capacitive storage element, a second conductive switch, and the first phase winding during the third operational state, and
conducting current through the first phase winding, the dc voltage supply, and a second unidirectional current device during the fourth operational state.

13. The method of claim 11, further comprising conducting current through the first phase winding during the fourth operational state in a direction opposite to the conduction of current through the first phase winding in the first operational state.

14. The method of claim 11, further comprising conducting current through the first phase winding during the third operational state in a direction opposite to the conduction of current through the first phase winding in the second operational state.

15. The method of claim 13, further comprising:
conducting current through the first phase winding in the same direction for the first and second operational states, and
conducting current through the first phase winding in the same direction for the third and fourth operational states.

16. The method of claim 14, further comprising:
conducting current through the first phase winding in the same direction for the first and second operational states, and
conducting current through the first phase winding in the same direction for the third and fourth operational states.

17. The method of claim 11, further comprising:
transferring energy from the dc voltage supply to a second phase winding during a fifth operational state,
transferring energy stored by the second phase winding of the electrical machine during the fifth operational state to the capacitive storage element during a sixth operational state, and
transferring energy stored by the capacitive storage element during the sixth operational state to the first phase winding during a seventh operational state.

18. The method of claim 17, further comprising:
conducting current through the dc voltage supply, the second phase winding, and a first conductive switch during the fifth operational state,
conducting current through the second phase winding, a unidirectional current device, and the capacitive storage element during the sixth operational state, and
conducting current through the capacitive storage element, a second conductive switch, and the first phase winding during the seventh operational state.

19. A power converter comprising:
a first electrical circuit comprising a direct current (dc) voltage source, a first phase winding of an electrical machine, and a first switch operating in a conductive state;
a second electrical circuit comprising the first phase winding, a first unidirectional current device, and a capacitive storage element;
a third electrical circuit comprising the capacitive storage element, a second switch operating in a conductive state, and the first phase winding; and
a fourth electrical circuit comprising the first phase winding, the dc voltage source, and a second unidirectional current device.

20. The power converter of claim 19, further comprising:
a fifth electrical circuit comprising the dc voltage source, a second phase winding of the electrical machine, and a third switch operating in a conductive state; and
a sixth electrical circuit comprising the second phase winding, a third unidirectional current device, and the capacitive storage element.

21. A power converter comprising:
a direct current (dc) voltage supply having a first terminal electrically connected directly to a first node and a second terminal electrically connected to a second node, either directly or through a first current sensor; and
a first phase module comprising:
a first phase winding of an electrical machine having a first terminal electrically connected directly to the first node and a second terminal electrically connected directly to a third node,
a capacitive storage element having a first terminal electrically connected directly to the first node and a second terminal electrically connected directly to a fourth node,
a first switch having a first terminal electrically connected to the second node, either directly or through a second current sensor, and a second terminal electrically connected directly to the third node,
a first unidirectional current device having a first terminal electrically connected to the second node, either directly or through the second current sensor, and a second terminal electrically connected directly to the third node,
a second switch having a first terminal electrically connected directly to the third node and a second terminal electrically connected directly to the fourth node, and
a second unidirectional current device having a first terminal electrically connected directly to the third node and a second terminal electrically connected directly to the fourth node.

22. The power converter of claim 21, further comprising a second phase module comprising:
a second phase winding of the electrical machine having a first terminal electrically connected directly to the first node and a second terminal electrically connected directly to a fifth node;
a third switch having a first terminal electrically connected to the second node, either directly or through a third current sensor, and a second terminal electrically connected directly to the fifth node; and
a third unidirectional current device having a first terminal electrically connected directly to the fifth node and a second terminal electrically connected directly to the fourth node.

23. The power converter of claim 22, further comprising multiple first phase modules and multiple second phase modules.

24. The power converter of claim 22, wherein each of the first, second, and third current sensors is a resistor.

25. The power converter of claim 21, further comprising a first voltage divider having a first terminal electrically connected directly to the first node and a second terminal electrically connected directly to the second node.

26. The power converter of claim 25, further comprising a second voltage divider having a first terminal electrically connected directly to the second node and a second terminal electrically connected directly to the third node.

27. The power converter of claim 26, wherein each of the first and second voltage dividers comprises two resistors electrically connected in series.

28. A method of controlling an electrical machine, the method comprising:
generating a first signal indicating whether a value representative of a voltage of a first voltage source is less than the difference between a value representative of a voltage of a second voltage source and a reference voltage value;
generating a second signal indicating whether the value representative of the voltage of the first voltage source equals or exceeds the sum of the value representative of the voltage of the second voltage source and the reference voltage value;
transferring energy from the second energy source to a phase winding of the electrical machine during a period that the first signal indicates an affirmative condition; and
transferring energy from the first energy source to the phase winding during a period that the second signal indicates an affirmative condition.

29. The method of claim 28 further comprising:
determining a current error representing the difference between a desired and an actual current conducted through the phase winding;
determining a duty cycle of current conduction through the phase winding based upon the determined current error;
transferring energy from the second energy source to the phase winding during a period that the duty cycle is active and the first signal indicates an affirmative condition; and
transferring energy from the first energy source to the phase winding during a period that the duty cycle is active and the second signal indicates an affirmative condition.

30. The method of claim 29 further comprising transferring energy to the phase winding only during the phase winding's dwell period.

31. A non-volatile storage medium storing instructions that, when executed by a processor, cause the processor to implement a method comprising:
transferring energy from a direct current (dc) voltage supply to a first phase winding of an electrical machine during a first operational state;
transferring energy stored by the first phase winding during the first operational state to a capacitive storage element during a second operational state;
transferring energy stored by the capacitive storage element to the first phase winding during a third operational state; and
transferring energy stored by the first phase winding during the third operational state to the dc voltage supply during a fourth operational state.

32. A non-volatile storage medium storing instructions that, when executed by a processor, cause the processor to implement a method comprising:
generating a first signal indicating whether a value representative of a voltage of a first voltage source is less than the difference between a value representative of a voltage of a second voltage source and a reference voltage value;
generating a second signal indicating whether the value representative of the voltage of the first voltage source equals or exceeds the sum of the value representative of the voltage of the second voltage source and the reference voltage value;
transferring energy from the second energy source to a phase winding of an electrical machine during a period that the first signal indicates an affirmative condition; and
transferring energy from the first energy source to the phase winding during a period that the second signal indicates an affirmative condition.
